(19) United States
(12) Patent Application Publication
(10) Pub. No.: US 2011/0277279 A1
(43) Pub. Date: Nov. 17, 2011

(54) Clip Having Exactly Positioning Function

(76) Inventor: Sung-Po Tsai, Sihu Township (TW)

(21) Appl. No.: 12/781,077

(22) Filed: May 17, 2010

(51) Int. Cl. F16B 2/20

(52) U.S. Cl. 24/499

(57) ABSTRACT

A clip includes two clamping pieces, a pivot shaft, and an elastic member. Each of the clamping pieces has a clamping portion, a pressing portion and a pivot seat. The pressing portion has a limit plate. The pivot seat has a limit slot and a shaft hole. The elastic member has two elastic legs each having a limit flange. Thus, each of the elastic legs is limited by the limit slot, and the limit flange is limited by the limit plate so that the clamping pieces and the elastic member are positioned exactly to prevent the clamping pieces from being vibrated and to prevent the elastic member from being detached from the clamping pieces. In addition, the elastic member is not subjected to a pressing force so that the elastic member will not produce an elastic fatigue.

### BACKGROUND OF THE INVENTION

1. Field of the Invention

The present invention relates to an accessory and, more particularly, to a clip.

2. Description of the Related Art

A conventional clip in accordance with the prior art shown in FIG. 4 comprises two clamping pieces 11 pivotally connected with each other by a pivot shaft 2, and an elastic member 3 mounted between the two clamping pieces 11. Each of the two clamping pieces 11 has a first end provided with a clamping portion 111 and a second end provided with a pressing portion 112. Each of the two clamping pieces 11 has a mediate portion formed with a limit groove 113. The elastic member 3 has two opposite elastic legs 31 each having a distal end provided with a limit block 311 received in the limit groove 113 of a respective one of the two clamping pieces 11.

In operation, when the pressing portions 112 of the clamping pieces 11 are pressed toward each other, the elastic legs 31 of the elastic member 3 are pressed by the clamping pieces 11 to store a restoring force, and the clamping pieces 11 are pivoted about the pivot shaft 2 so that the clamping portions 111 of the clamping pieces 11 are moved outward relative to each other to provide a clamping function. After the force applied on the pressing portions 112 of the clamping pieces 11 disappears, the pressing portions 112 of the clamping pieces 11 are moved outward relative to each other by the restoring force of the elastic member 3 so that the clamping portions 111 of the clamping pieces 11 are moved toward each other to the original state.

However, the limit block 311 of each of the elastic legs 31 of the elastic member 3 is not secured in the limit groove 113 of the respective clamping piece 11 exactly and closely so that each of the elastic legs 31 of the elastic member 3 is not exactly positioned on the respective clamping piece 11 and is easily detached from the respective clamping piece 11 during operation of the clamping pieces 11. In addition, each of the elastic legs 31 of the elastic member 3 is not positioned on the respective clamping piece 11 exactly so that the clamping pieces 11 are easily vibrated when the pressing portions 112 of the clamping pieces 11 are pressed toward each other. Further, each of the elastic legs 31 of the elastic member 3 is pressed by the respective clamping piece 11 at a normal state so that the elastic member 3 easily produces an elastic fatigue.

### BRIEF SUMMARY OF THE INVENTION

In accordance with the present invention, there is provided a clip, comprising two clamping pieces pivotally connected with each other by a pivot shaft, and an elastic member mounted between the two clamping pieces. Each of the two clamping pieces has a first end provided with a clamping portion and a second end provided with a pressing portion. The pressing portion of each of the two clamping pieces has an inner portion provided with a limit plate. Each of the two clamping pieces has a side provided with a pivot seat. The pivot seat of each of the two clamping pieces has a first end formed with a limit slot and a second end formed with a shaft hole. The pivot shaft in turn extends through the shaft hole of the pivot seat of each of the two clamping pieces so that the pivot seats of the two clamping pieces are pivotally connected with each other by the pivot shaft. The elastic member has two opposite elastic legs each extended through and limited by the limit slot of the pivot seat of a respective one of the two clamping pieces. Each of the two elastic legs of the elastic member has a distal end provided with a limit flange abutting the limit plate of the pressing portion of the respective clamping piece.

The primary objective of the present invention is to provide a clip having an exactly positioning function.

According to the primary objective of the present invention, each of the elastic legs of the elastic member is extended through and limited by the limit slot of the respective clamping piece, while the limit flange of each of the elastic legs is locked onto and limited by the limit plate of the respective clamping piece so that the clamping pieces and the elastic member are positioned exactly and stably so as to prevent the clamping pieces from being vibrated during movement, and to prevent the elastic member from being detached from the clamping pieces during operation of the clamping pieces.

According to another objective of the present invention, the elastic member is not subjected to a pressing force before the pivot action of the clamping pieces so that the elastic member will not produce an elastic fatigue due to a stress concentration during a long-term utilization so as to enhance the lifetime of the elastic member.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a clip in accordance with the preferred embodiment of the present invention.

FIG. 2 is a front cross-sectional assembly view of the clip as shown in

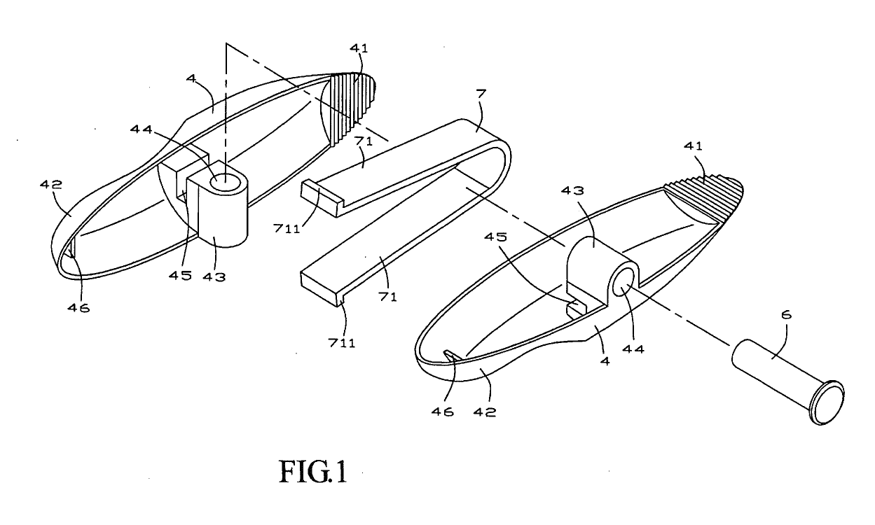

FIG. 1.

FIG. 3 is an exploded perspective view of a clip in accordance with another preferred embodiment of the present invention.

FIG. 4 is a front cross-sectional assembly view of a conventional clip in accordance with the prior art.

### DETAILED DESCRIPTION OF THE INVENTION

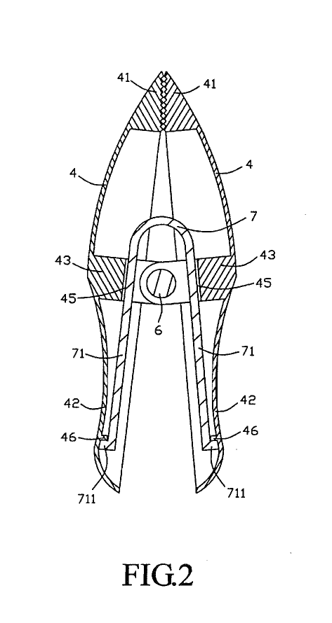

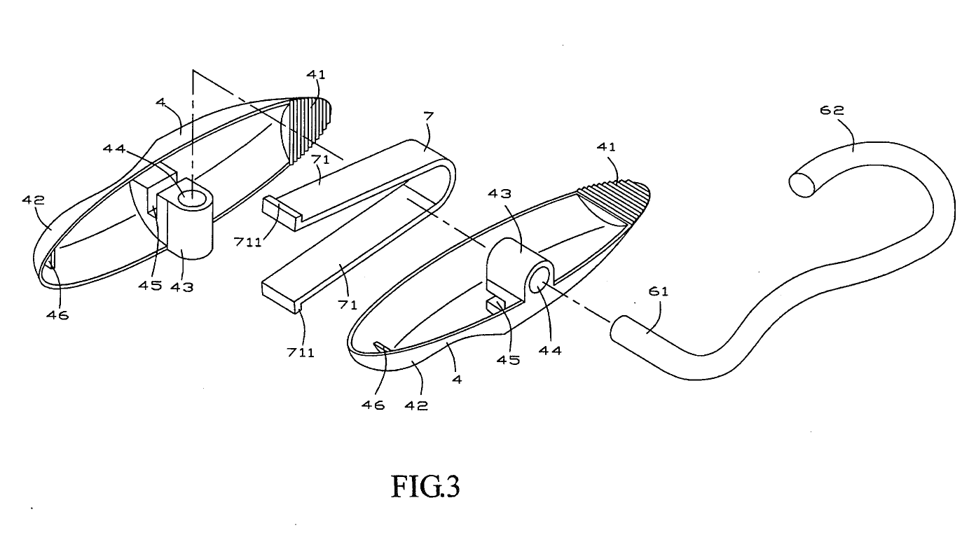

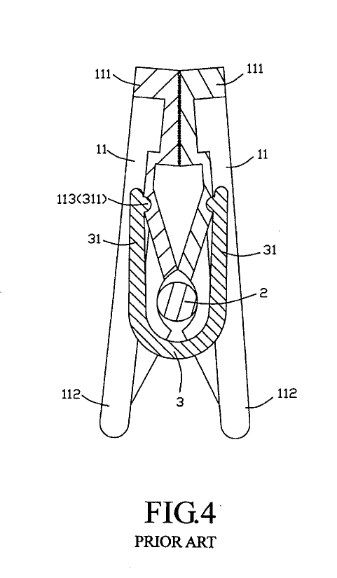

Referring to the drawings and initially to FIGS. 1 and 2, a clip in accordance with the preferred embodiment of the present invention comprises two clamping pieces 4 pivotally connected with each other by a pivot shaft 6, and an elastic member 7 mounted between the two clamping pieces 4.

Each of the two clamping pieces 4 has a first end provided with a clamping portion 41 and a second end provided with a pressing portion 42. The pressing portion 42 of each of the two clamping pieces 4 has an inner portion provided with a limit plate 46. Each of the two clamping pieces 4 has a side provided with a pivot seat 43. The pivot seat 43 of each of the two clamping pieces 4 has a first end formed with a limit slot 45 and a second end formed with a shaft hole 44. The limit slot 45 of the pivot seat 43 of each of the two clamping pieces 4 is received in each of the two clamping pieces 4 and is disposed between the clamping portion 41 and the limit plate 46.

The pivot seat 43 of each of the two clamping pieces 4 is located at a middle position of each of the two clamping pieces 4. The pivot seat 43 of each of the two clamping pieces 4 is disposed between the clamping portion 41 and the pressing portion 42 and protrudes outwardly from each of the two clamping pieces 4. The pivot seat 43 of each of the two clamping pieces 4 is extended in a transverse direction of each of the two clamping pieces 4. The shaft hole 44 of the pivot seat 43 of each of the two clamping pieces 4 is extended in the transverse direction of each of the two clamping pieces 4 and in an axial direction of the pivot seat 43 of each of the two clamping pieces 4.

The pivot shaft 6 in turn extends through the shaft hole 44 of the pivot seat 43 of each of the two clamping pieces 4 so that the pivot seats 43 of the two clamping pieces 4 are pivotally connected with each other by the pivot shaft 6.

The elastic member 7 is a substantially inverted U-shaped elastic plate. The elastic member 7 has two opposite elastic legs 71 each extended through and limited by the limit slot 45 of the pivot seat 43 of a respective one of the two clamping pieces 4. Each of the two elastic legs 71 of the elastic member 7 has a distal end provided with a limit flange 711 abutting the limit plate 46 of the pressing portion 42 of the respective clamping piece 4.

In operation, when the pressing portions 42 of the clamping pieces 4 are pressed toward each other, the elastic legs 71 of the elastic member 7 are pressed by the pressing portions 42 of the clamping pieces 4 to store a restoring force, and the pivot seats 43 of the clamping pieces 4 are pivoted about the pivot shaft 6 so that the clamping portions 41 of the clamping pieces 4 are moved outward relative to each other to provide a clamping function. After the force applied on the pressing portions 42 of the clamping pieces 4 disappears, the pressing portions 42 of the clamping pieces 4 are moved outward relative to each other by the restoring force of the elastic member 7 so that the clamping portions 41 of the clamping pieces 4 are moved toward each other to the original state as shown in FIG. 2.

In such a manner, each of the elastic legs 71 of the elastic member 7 is limited by the limit slot 45 of the respective clamping piece 4, and the limit flange 711 of each of the elastic legs 71 is limited by the limit plate 46 of the respective clamping piece 4 so that the clamping pieces 4 and the elastic member 7 are positioned exactly and stably to prevent the clamping pieces 4 from being vibrated during movement, and to prevent the elastic member 7 from being detached from the clamping pieces 4 during operation. In addition, the elastic member 7 is not subjected to a pressing force before the pivot action of the clamping pieces 4 so that the elastic member 7 will not produce an elastic fatigue during a long-term utilization to enhance the lifetime of the elastic member 7.

As shown in FIG. 3, the pivot shaft 61 has a distal end provided with a hanging hook 62.

Accordingly, each of the elastic legs 71 of the elastic member 7 is extended through and limited by the limit slot 45 of the respective clamping piece 4, while the limit flange 711 of each of the elastic legs 71 is locked onto and limited by the limit plate 46 of the respective clamping piece 4 so that the clamping pieces 4 and the elastic member 7 are positioned exactly and stably so as to prevent the clamping pieces 4 from being vibrated during movement, and to prevent the elastic member 7 from being detached from the clamping pieces 4 during operation of the clamping pieces 4. In addition, the elastic member 7 is not subjected to a pressing force before the pivot action of the clamping pieces 4 so that the elastic member 7 will not produce an elastic fatigue due to a stress concentration during a long-term utilization so as to enhance the lifetime of the elastic member 7.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A clip, comprising:
two clamping pieces pivotally connected with each other by a pivot shaft; and
an elastic member mounted between the two clamping pieces;
wherein each of the two clamping pieces has a first end provided with a clamping portion and a second end provided with a pressing portion;
the pressing portion of each of the two clamping pieces has an inner portion provided with a limit plate;
each of the two clamping pieces has a side provided with a pivot seat;
the pivot seat of each of the two clamping pieces has a first end formed with a limit slot and a second end formed with a shaft hole;
the pivot shaft in turn extends through the shaft hole of the pivot seat of each of the two clamping pieces so that the pivot seats of the two clamping pieces are pivotally connected with each other by the pivot shaft;
the elastic member has two opposite elastic legs each extended through and limited by the limit slot of the pivot seat of a respective one of the two clamping pieces;
each of the two elastic legs of the elastic member has a distal end provided with a limit flange abutting the limit plate of the pressing portion of the respective clamping piece.

2. The clip of claim 1, wherein the pivot seat of each of the two clamping pieces is located at a middle position of each of the two clamping pieces.

3. The clip of claim 1, wherein the pivot seat of each of the two clamping pieces is extended in a transverse direction of each of the two clamping pieces.

4. The clip of claim 3, wherein the shaft hole of the pivot seat of each of the two clamping pieces is extended in the transverse direction of each of the two clamping pieces.

5. The clip of claim 1, wherein the shaft hole of the pivot seat of each of the two clamping pieces is extended in an axial direction of the pivot seat of each of the two clamping pieces.

6. The clip of claim 1, wherein the limit slot of the pivot seat of each of the two clamping pieces is received in each of the two clamping pieces.

7. The clip of claim 1, wherein the limit slot of the pivot seat of each of the two clamping pieces is disposed between the clamping portion and the limit plate.

8. The clip of claim 1, wherein the pivot seat of each of the two clamping pieces is disposed between the clamping portion and the pressing portion.

9. The clip of claim 1, wherein the pivot seat of each of the two clamping pieces protrudes outwardly from each of the two clamping pieces.

10. The clip of claim 1, wherein the elastic member is a substantially inverted U-shaped elastic plate.

11. The clip of claim 1, wherein the pivot shaft has a distal end provided with a hanging hook.
